(19) United States
(12) Patent Application Publication
(10) Pub. No.: US 2017/0094292 A1
(43) Pub. Date: Mar. 30, 2017

(54) METHOD AND DEVICE FOR PARALLEL CODING OF SLICE SEGMENTS

(71) Applicant: SAMSUNG ELECTRONICS CO., LTD., Suwon-si (KR)

(72) Inventors: Mohammed Quaid DAMUDI, Bangalore (IN); Austin LOBO, Bangalore (IN)

(73) Assignee: SAMSUNG ELECTRONICS CO., LTD., Suwon-si (KR)

(21) Appl. No.: 15/258,388

(22) Filed: Sep. 7, 2016

(30) Foreign Application Priority Data
Sep. 28, 2015 (IN) 5183/CHE/2015

(51) Int. Cl. H04N 19/436; H04N 19/174

(52) U.S. Cl. CPC H04N 19/436; H04N 19/174; H04N 19/129

(57) ABSTRACT

A slice coding method and apparatus for performing slice coding of a base slice segment and dependent slice segments and inverse dependent slice segments in parallel with respect to the base slice segment.

### CROSS-REFERENCE TO RELATED APPLICATION

This application claims priority from Indian Patent Application No. 5183/CHE/2015 filed on Sep. 28, 2015, in the Indian Patent Office, the disclosure of which is incorporated herein by reference in its entirety.

### BACKGROUND

1. Field

Methods and apparatuses consistent with exemplary embodiments of the present application relate to coding systems, and more particularly to a method and apparatus for parallel coding of slice segments.

2. Description of Related Art

Digital video plays an important role in a host of applications, ranging from video conferencing and digital video discs (DVDs) to digital TV, mobile video, and Internet video streaming and sharing. Video coding standards exploit redundancies of video data in spatial and temporal domains to compress an original video signal, thereby reducing transmission costs. In addition to encoding video data in the spatial and temporal domains, various other techniques aim to improve error resilience, compression, parallel decoding, network adaption, and so on. Slice coding is one such method in which a picture is divided into a plurality of slice segments to achieve error resilience, independent decoding capability, and adaptation to the maximum transmission unit (MTU) size of the underlying communication network.

Some video coding standards, such as the high efficiency video coding (HEVC) standard (i.e., H.265) implement slice segment coding. In the HEVC standard, slice segments are sequentially coded based on dependency of the slice segments with respect to a base slice segment (independent slice segment). In slice coding, encoding speed of sequentially encoding the slice segments is especially affected in the case of multi-core architectures.

Further, the HEVC standard incorporates a technique known as wavefront parallel processing (WPP), which enables creation of picture partitions that can be processed in parallel without incurring large coding losses. Further, in WPP, rows of treeblocks are processed in parallel while preserving all coding dependencies. However, in WPP, threads of execution of partitions should be synchronized through costly inter process or thread communication, as individual threads representative of coding rows of picture have cross dependencies, which may add additional complexity impeding execution of coding the picture.

### SUMMARY

Aspects of the exemplary embodiments of the present disclosure provide a mechanism for parallel coding of slice segments.

Aspects of the exemplary embodiments of the present disclosure provide a mechanism for partitioning a frame into a plurality of slice segments. The plurality of slice segments include a base slice segment, a dependent slice segment and an inverse dependent slice segment.

Aspects of the exemplary embodiments of the present disclosure provide a mechanism for coding the dependent slice segment and the inverse dependent slice segment in parallel with respect to the base slice segment.

Aspects of the exemplary embodiments of the present disclosure provide a mechanism for coding the dependent slice segment in a raster scan order and inverse dependent slice segment in an inverse raster scan order.

Aspects of the exemplary embodiments of the present disclosure provide a mechanism for coding one or more tiles formed from a set of slice segments.

According to an aspect of an exemplary embodiment, there is provided a method for coding a frame including partitioning a frame into a plurality of slice segments, the plurality of segments including a base slice segment, a dependent slice segment, and an inverse dependent slice segment, coding the base slice segment, coding the dependent slice segment and the inverse dependent slice segment in parallel with respect to the base slice segment.

According to an aspect of an exemplary embodiment, there is provided an electronic device for coding a frame including a partitioning unit configured to partition the frame into a plurality of slice segments, the plurality of slice segments including a base slice segment, a dependent slice segment, and an inverse dependent slice segment, to code the base slice segment, and to code the dependent slice segment and the inverse dependent slice segment in parallel with respect to the base slice segment.

According to an aspect of an exemplary embodiment, there is provided a computer program product comprising computer executable program code recorded on a non-transitory computer readable storage medium for executing a method of coding a frame including partitioning a frame into a plurality of slice segments, the plurality of slice segments comprising a base slice segment, a dependent slice segment, and an inverse dependent slice segment, coding the base slice segment, and coding the dependent slice segment and the inverse dependent slice segment in parallel with respect to the base slice segment.

and the above and other aspects of the exemplary embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the exemplary embodiments herein without departing from the spirit thereof, and the embodiments herein include all such modifications.

### BRIEF DESCRIPTION OF THE DRAWINGS

Aspects of the present disclosure are illustrated in the accompanying drawings, throughout which like reference letters indicate corresponding parts in the various figures. The exemplary embodiments herein will be better understood from the following description with reference to the drawings, in which:

FIG. 1 illustrates a block diagram of an electronic device for parallel coding of slice segments, according to an exemplary embodiment;

FIG. 2A illustrates an example of a frame segmented into a plurality of slice segments, according to an exemplary embodiment;

FIG. 2B illustrates an example of a frame segmented into a plurality of tiles having slice segments, according to an exemplary embodiment;

FIGS. 3A and 3B illustrate an example frame in which dependent slice segments and inverse dependent slice segments are coded in raster scan order and inverse raster scan order respectively, according to exemplary embodiments;

FIG. 4 is a flow chart illustrating a method for parallel coding of slice segments of a frame having a single base slice segment and a plurality of dependent slice segments, according to an exemplary embodiment;

FIG. 5 is a diagram illustrating an example for parallel coding of slice segments of a frame having a single base slice segment and a plurality of dependent slice segments, according to an exemplary embodiment;

FIG. 6 is a flow chart illustrating a method for parallel coding of slice segments of a frame having two base slice segments and a plurality of dependent slice segments, according to an exemplary embodiment;

FIG. 7 is a diagram illustrating an example for parallel coding of slice segments of a frame having two base slice segments and a plurality of dependent slice segments, according to an exemplary embodiment; and

FIG. 8 illustrates a block diagram of a computing environment implementing the method for parallel coding of slice segments, according to an exemplary embodiment.

### DETAILED DESCRIPTION OF THE EXEMPLARY EMBODIMENTS

The disclosure and the various features and advantageous details thereof are explained more fully with reference to the non-limiting exemplary embodiments and the accompanying drawings. Descriptions of well-known components and processing techniques are omitted to avoid unnecessarily obscuring the exemplary embodiments. Also, the various exemplary embodiments described herein are not necessarily mutually exclusive, as some exemplary embodiments may be combined with one or more other exemplary embodiments to form new embodiments.

The term “or” as used herein, refers to a non-exclusive or, unless otherwise indicated.

As used herein, the term “and/or” includes any and all combinations of one or more of the associated listed items.

Expressions such as “at least one of,” when preceding a list of elements, modify the entire list of elements and do not modify the individual elements of the list.

It will be understood that the terms “comprise” and/or “comprising” when used in this specification, specify the presence of stated features, integers, steps, operations, elements, and/or components, but do not preclude the presence or addition of one or more other features, integers, steps, operations, elements, components, and/or groups thereof.

Also, the terms “unit”, “module”, etc. mean units for processing at least one function or operation and may be embodied as hardware, software, or a combination thereof.

The examples used herein are intended merely to facilitate an understanding of ways in which the exemplary embodiments herein may be practiced and to further enable those skilled in the art to practice the exemplary embodiments. Accordingly, the examples should not be construed as limiting the scope of the exemplary embodiments herein.

Prior to describing the embodiments in detail, definitions for key terms used herein are provided. Unless defined otherwise, all technical terms used herein have the meaning as commonly understood by a person having ordinary skill in the art of video coding to which this disclosure belongs.

Network Abstraction Layer (NAL) unit: non-exclusively refers to a syntax structure indicating a type of data to follow. In an exemplary embodiment, bytes representing such data may be expressed in the form of Raw Byte Sequence Payload (RBSP) interspersed as necessary with emulation prevention bytes.

Slice segment: non-exclusively refers to an integer number of coding tree units consecutively ordered and contained in a single NAL unit. A single slice segment may be encapsulated in a single NAL unit. It is the responsibility of the video encoder to ensure that the sizes of the slice segments in an output bit stream comply with a maximum allowed NAL unit size.

Base slice segment or Independent slice segment: non-exclusively refers to a slice segment for which values of syntax elements of a slice segment header are not inferred from values for a preceding slice segment.

Dependent slice segment: non-exclusively refers to a slice segment for which values of some syntax elements of a slice segment header are inferred from values of a preceding independent slice segment in decoding order.

Inverse dependent slice segment: non-exclusively refers to a slice segment which is inversely dependent on a base slice segment. In general, some syntax elements of an inverse dependent slice are inferred from values for a preceding independent slice segment in decoding order.

Wavefront parallel processing (WPP): non-exclusively refers to creation of picture partitions that may be processed in parallel without incurring high coding losses. WPP processes rows of tree blocks in parallel while preserving all coding dependencies.

Frame: non-exclusively refers to a picture or a field of a picture. It should be understood that the “frame” refers to a complete picture (image) captured during a known time interval.

The exemplary embodiments herein achieve a method for coding a frame. The method includes partitioning, by a partitioning unit, a frame into a plurality of slice segments including a base slice segment, a dependent slice segment, and an inverse dependent slice segment. Further, the method includes coding the by a coding unit, the base slice segment. Furthermore, the method includes coding by the coding unit, the dependent slice segment and the inverse dependent slice segment in parallel with respect to the base slice segment.

Unlike the conventional systems and methods, aspects of the exemplary embodiments enable coding of the dependent slice segments and inverse dependent slice segments in parallel with respect to the base slice segment. A parallelism is achieved in coding the dependent slice segments as opposed to the conventional systems and methods. The inverse dependent slice segments are coded in the inverse raster scan order and the dependent slice segments are coded in the raster scan order, whereas in the conventional methods, the slice segments are sequentially coded.

Further, a plurality of base slice segments in the frame are coded in parallel and the dependent slice segments associated with each base slice segment are independently coded in parallel thread of execution. In an exemplary embodiment, there exists two threads of execution for coding the dependent slice segments. A first thread codes the inverse dependent slice segments above the base slice segment in the raster scan order and a second thread codes the dependent slice segments below the base slice segment in the inverse raster scan order. Thus, multiple threads in a single frame are executed to improve execution speed and coding gains are achieved. In the proposed method, there is no need of any synchronization between two parallel threads coding a set of inverse dependent slice segments and dependent slice segments, in contrast to WPP.

In an exemplary embodiment, higher coding (compression) gains relative to processing of tiles may be achieved, as the concept of inverse dependent slice segment allows two dependent slice segments (inverse dependent slice segments and dependent slice segments) to reference one base slice segment. The need to synchronize between two threads of execution of inverse dependent slice segment and normal dependent slice segment may be eliminated, thereby achieving increased execution speed.

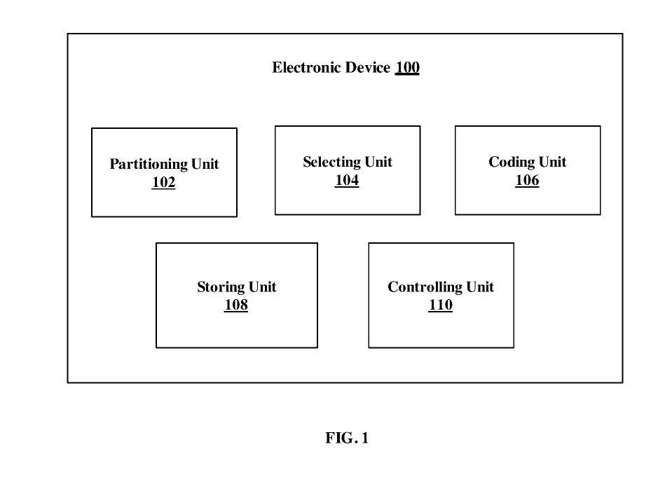

Referring now to the drawings, and more particularly to FIGS. 1 through 8, where similar reference characters denote corresponding features consistently throughout the figures, there are shown exemplary embodiments.

FIG. 1 illustrates a block diagram of an electronic device for parallel coding of slice segments, according to an exemplary embodiment.

As depicted in the FIG. 1, the electronic device 100 includes a partitioning unit 102, a selecting unit 104, a coding unit 106, a storing unit 108, and a controlling unit 110.

The partitioning unit 102 may be configured to partition the frame into a plurality of slice segments. The plurality of slice segments include the base slice segment, the dependent slice segment, and the inverse dependent slice segment. The dependent slice segment and the inverse dependent slice segment are adjacent neighbors of the base slice segment.

The selecting unit 104 may be configured to select the base slice segment from the plurality of slice segments in the frame.

The base slice segment is selected from any portion of the frame.

The coding unit 106 may be configured to perform one or more actions for coding the plurality of slice segments in the frame. The coding unit 106 may be configured to independently code the base slice segment in the raster scan order. Further, the coding unit 106 may be configured to code in parallel the dependent slice segment in the raster scan order and the inverse dependent slice segment in the inverse raster scan order with respect to the base slice segment. Thus, parallelism is achieved in coding the dependent slice segments, as opposed to conventional systems and methods. Accordingly, the inverse dependent slice segments are coded in the inverse raster scan order and the dependent slice segments are coded in the raster scan order, whereas in the conventional methods, the slice segments are sequentially coded.

The storing unit 108 stores the plurality of slice segments in the frame. The storing unit 108 may include one or more computer-readable storage media. The storing unit 108 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storing unit 108 may, in some examples, be considered a non-transitory storage medium. The term “non-transitory” may indicate that the storage medium is not embodied in a carrier wave or a propagated signal. However, the term “non-transitory” should not be interpreted that the storage unit 108 is non-movable. In some examples, the storing unit 108 can be configured to store larger amounts of information and have capacity greater than conventional memory. In certain examples, a non-transitory storage medium may store data that can, over time, change (e.g., in Random Access Memory (RAM) or cache).

The controlling unit 110 may be configured to perform one or more actions associated with the partitioning unit 102, the selecting unit 104 and the coding unit 106. The controlling unit 110 may be implemented by a processor, microprocessor, central processing unit, controller, or any other controlling means of a video coding apparatus. The controlling unit 110 may be configured to determine the dependent slice segments and the inverse dependent slice segments with respect to the base slice segment.

The controlling unit 110 may be configured to determine whether the dependent slice segment is present below the base slice segment. If the dependent slice segment is below the base slice segment then, the controlling unit 110 may be configured to indicate the determination result to the coding unit 106. After receiving the indication from the controlling unit 110, the coding unit 106 may be configured to code the dependent slice segment in the raster scan order.

Further, the controlling unit 110 may be configured to determine whether the inverse dependent slice segment is present above the base slice segment. If the inverse dependent slice segment is above the base slice segment then, the controlling unit 110 may be configured to indicate the determination result to the coding unit 106. After receiving the indication from the controlling unit 110, the coding unit may be configured to code the dependent slice segment in the inverse raster scan order.

The FIG. 1 shows a limited overview of the electronic device 100 but, it is to be understood that other embodiments are not limited thereto. The labels or names of the units are used only for illustrative purpose and does not limit the scope of the disclosure. Further, the electronic device 100 can include any number of units or sub-units communicating among each other along with the other components.

Likewise, the functionalities of one or more units can be combined by a single unit or can be distributed among each other in a manner different than described herein without departing from the scope of the disclosure. For example, as discussed above, functionality of the partitioning unit 102, the selecting unit 104, and the coding unit 106 may be provided by the controlling unit 110.

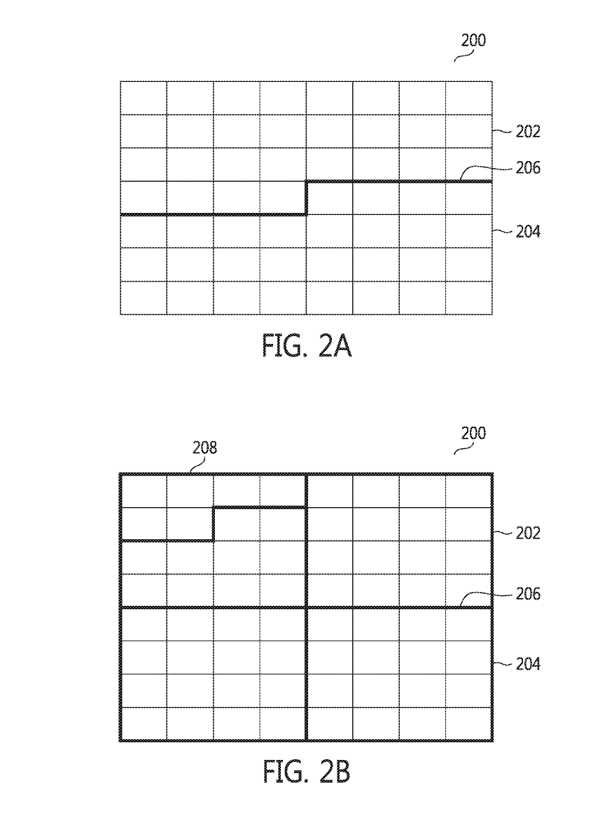

FIG. 2A illustrates an example of a frame segmented into a plurality of slice segments, according to an exemplary embodiment. As depicted in FIG. 2A, the frame 200 includes a first slice segment 202 and a second slice segment 204. A slice boundary 206 (with darkened line) is shown between the first slice segment 202 and the second slice segment 204.

FIG. 2B illustrates an example of a frame 200 segmented into a plurality of tiles having slice segments, according to an exemplary embodiment.

A set of slice segments from a plurality of slice segments form a tile. The tile is composed of one or more slice segments. A tile 208 (a square shaped upper left quadrant of frame 200 with darkened lines) with two slice segments 222, 224 is shown in the FIG. 2B. The frame 200 shown in the FIG. 2B includes four tiles, one in each quadrant of the frame, but the shape of the tiles is not limited thereto.

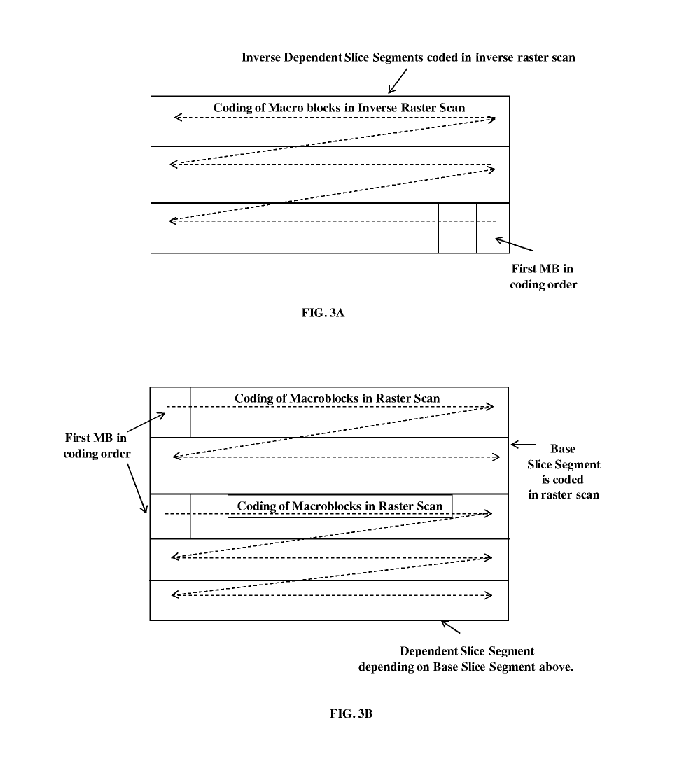

FIGS. 3A and 3B illustrate an example frame schematic in which dependent slice segments and inverse dependent slice segments are coded in raster scan order and inverse raster scan order respectively, according to an exemplary embodiment.

The base slice segment is selected from any portion of the frame 200. The selection of the base slice from the frame 200 is performed to achieve high coding gains using encoding techniques based on details and complexities of the frame 200. The base slice segment is independently coded in the raster scan order, as the base slice segment does not depend on other slice segments in the frame 200.

As depicted in FIG. 3A, a first macroblock (MB) of each of the slice segments is marked. The inverse dependent slice segments depend on the base slice segment. As the inverse dependent slice segments depend on the base slice segment below, the inverse dependent slice segments are coded in inverse raster scan order, as shown in FIG. 3A.

A coding order of macroblocks or coding units for the inverse dependent slice segments is in the inverse raster scan order.

As depicted in the FIG. 3B, the first MB of each of the slice segments is marked. Further, the coding order of the macroblock or coding unit for the base slice segment and the normal dependent slice segment is in the raster scan order, as shown in the FIG. 3B.

It should be noted that the dependent slice segments and the inverse dependent slice segments that depend on the base slice segment are coded in parallel, as there is no dependency between the inverse dependent slice segments and the dependent slice segments. Thus, the proposed method allows coding of the dependent slice segments and inverse dependent slice segments in parallel with respect to the base slice segment, as opposed to the conventional methods. Further, a plurality of base slice segments in the frame are coded in parallel and the dependent slice segments associated with each base slice segment are independently coded in a parallel thread of execution.

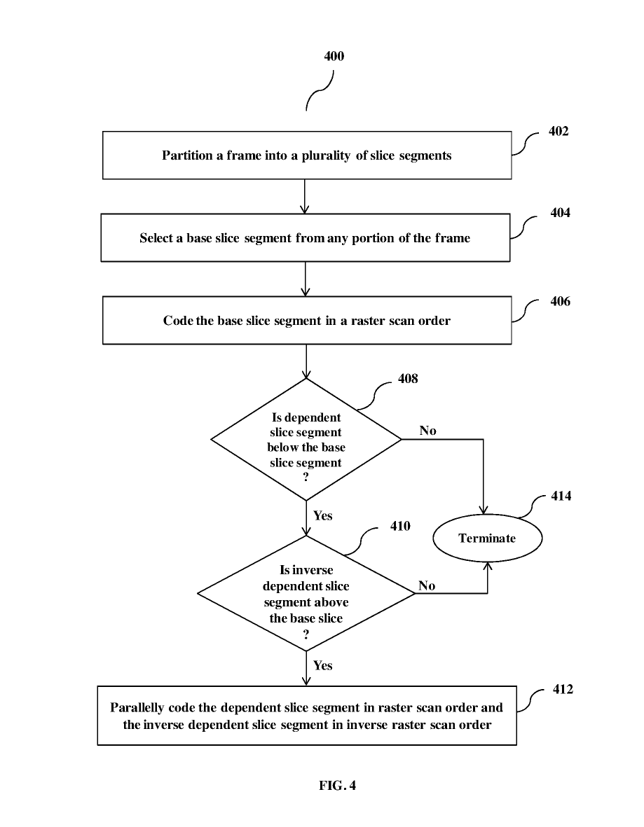

FIG. 4 is a flow chart illustrating a method 400 for parallel coding of slice segments of a frame having a single base slice segment and a plurality of dependent slice segments, according to an exemplary embodiment.

At step 402, the frame is partitioned into slice segments. With reference to FIG. 1, the partitioning unit 102 may partition the frame into the plurality of slice segments.

At step 404, the base slice segment is selected. The base slice segment may be selected from any portion of the frame 200. With reference to FIG. 1, the selecting unit 104 may select the base slice segment from any portion of the frame.

At step 406, the base slice segment is coded in raster scan order. With reference to FIG. 1, the coding unit 106 may code the base slice segment in raster scan order.

At step 408, the method 400 includes determining whether the dependent slice segment is below the base slice segment. With reference to FIG. 1, the controlling unit 110 may determine whether the dependent slice segment is below the base slice segment.

If it is determined that the dependent slice segment is below the base slice segment at step 408, then at step 412, it is determined whether the inverse dependent slice segment is above the base slice segment. With reference to FIG. 1, the controlling unit 110 may determine whether the inverse dependent slice segment is above the base slice segment.

If it is determined that the inverse dependent slice segment is above the base slice segment at step 410, then at step 412, the dependent slice segment may be coded in raster scan order and the inverse dependent slice segment may be coded in the inverse raster scan order, in parallel. With reference to FIG. 1, the coding unit 106 may code the dependent slice segment in the raster scan order and code the inverse dependent slice segment in the inverse raster scan order, in parallel.

If it is determined that the inverse dependent slice segment is not above the base slice segment at step 410, then the method is terminated at step 414.

If it is determined that the dependent slice segment is not below the base slice at in step 408, then the method is terminated at step 414.

The above described method 400 allows coding of the dependent slice segments and inverse dependent slice segments in parallel with respect to the base slice segment. A parallelism is achieved in coding the dependent slice segments, as opposed to the conventional systems and methods.

The various actions, acts, blocks, steps, or the like in the method 400 may be performed in the order presented, in a different order or simultaneously. Further, in some embodiments, some of the actions, acts, blocks, steps, or the like may be omitted, added, modified, skipped, or the like without departing from the scope of the invention.

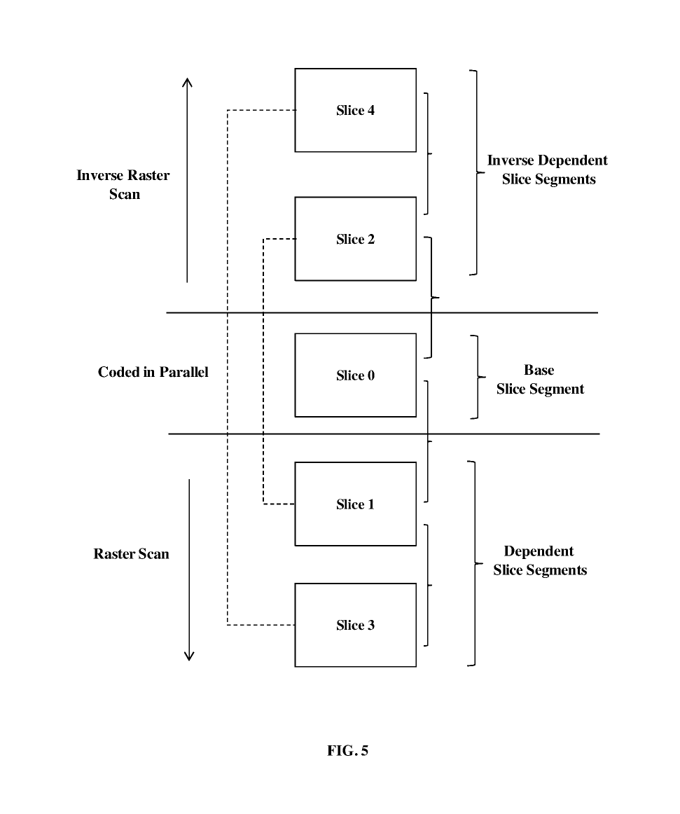

FIG. 5 is a diagram illustrating an example for parallel coding of slice segments of a frame having a single base slice segment and a plurality of dependent slice segments, according to an exemplary embodiment.

In FIG. 5, the frame is partitioned into five slice segments. Slice 0 is the base slice segment, and slice 1 and slice 3 are dependent slice segments. Slice 2 and slice 4 are inverse dependent slice segments. Slices 1, 2, 3 and 4 are neighboring slices to the slice 0. It is to be noted that slice 1 is dependent on the base slice (slice 0) and slice 3 is dependent on the slice 2. Further, it is to be noted that slice 2 is inversely dependent on the base slice (slice 0) and slice 4 is inversely dependent on slice 2.

In this example, with reference to FIG. 1, the selecting unit 104 may select slice 0 as the base slice segment. When slice segment 0 is selected as the base slice segment, the coding unit 106 may code the slice segment 0 in the raster scan order. The coding unit 106 may code the slice segments 1 and 3 in the raster scan order and slice segments 2 and 4 in the inverse raster scan order.

The coding unit 106 may code the slice segments 1 and 2 in parallel with respect to slice 0. Further, the coding unit 106 may code the slice segments 3 and 4 in parallel with respect to slice 0. Thus, the proposed method achieves parallelism in coding the dependent slice segments, as opposed to the conventional methods.

Further, the inverse dependent slice segments are coded in the inverse raster scan order and the dependent slice segments are coded in the raster scan order, whereas in the conventional methods, the dependent slice segments are coded sequentially.

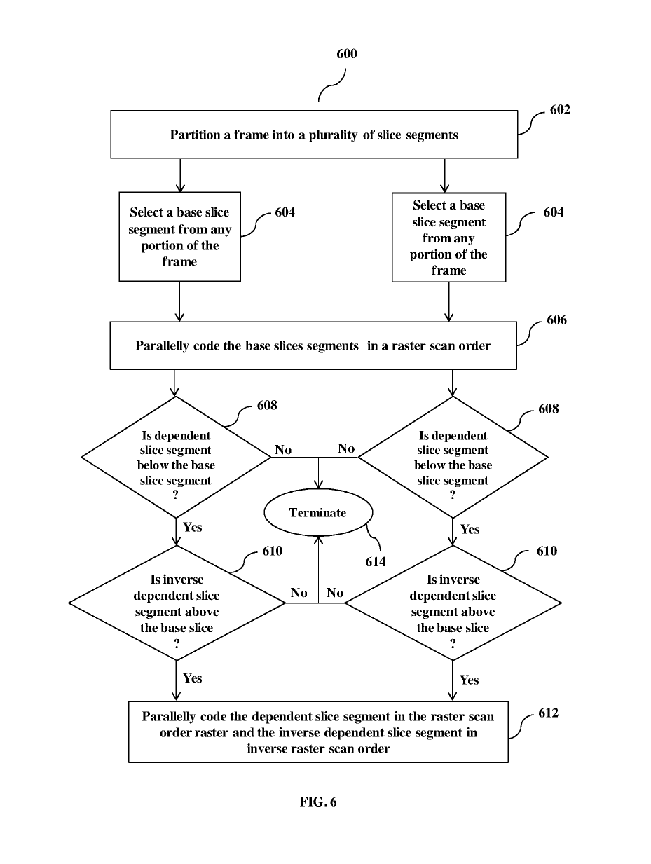

FIG. 6 is a flow chart illustrating a method 600 for parallel coding of slice segments of a frame having two base slice segments and a plurality of dependent slice segments, according to an exemplary embodiment.

The method 600 includes various steps for coding the frame when the plurality of base slice segments and the plurality of dependent slice segments are present in the frame 200. From the flow diagram it is to be understood that the coding is performed on the plurality of base slice segments in parallel. Further, the plurality of dependent slice segments are also coded in parallel with respect to the base slice segments. In the flow diagram, it is shown that the coding of base slice segments and the coding of dependent slice segments with respect to the base slice segment independently occur in a parallel manner. Same reference numerals are shown to indicate that the coding of the plurality base slice segments and the coding of the plurality of dependent slice segments with respect to the plurality of base slice segments independently occur in a parallel manner.

At step 602, the frame is partitioned into the plurality of slice segments. With reference to FIG. 1, the partitioning unit 102 may partition the frame into the plurality of slice segments.

At step 604, the base slice segment is selected from the frame. The base slice segment may be selected from any portion of the frame. With reference to FIG. 1, the selecting unit 104 may select the base slice segment from any portion of the frame.

At step 606, the base slice segment is coded in the raster scan order. With reference to FIG. 1, the coding unit 106 may code the base slice segment in the raster scan order.

At step 608, it is determined whether the dependent slice segment is below the base slice segment. With reference to FIG. 1, the controlling unit 110 may determine whether the dependent slice segment is below the base slice segment.

If it is determined that the dependent slice segment is below the base slice segment at step 608, then at step 610, it is determined whether the inverse dependent slice segment is above the base slice segment. With reference to FIG. 1, the controlling unit 110 may determine whether the inverse dependent slice segment is above the base slice segment.

If it is determined that the inverse dependent slice segment is above the base slice segment at step 610, then at step 612, the dependent slice segment is coded in raster scan order and the inverse dependent slice segment is coded in the inverse raster scan order, in parallel. With reference to FIG. 1, the coding unit 106 may code the dependent slice segment in raster scan order and code the inverse dependent slice segment in the inverse raster scan order, in parallel.

If it is determined that the inverse dependent slice segment is not above the base slice segment as in step 610, the method is terminated at step 614.

If it is determined that the dependent slice segment is not below the base slice as in step 608, the method is terminated at step 614.

The above described method allows independent coding of the plurality of base slice segments in parallel. Further, the dependent slice segments associated with each base slice segment are independently coded in a parallel thread of execution. In an exemplary embodiment, there may be two threads of execution for coding the dependent slice segments: a first thread codes the inverse dependent slice segments above the base slice segment in the raster scan order and second thread codes the dependent slice segments below the base slice segment in the inverse raster scan order. Thus, multiple threads in a single frame are executed to improve execution speed and achieve improved coding gains.

The various actions, acts, blocks, steps, or the like in the method may be performed in the order presented, in a different order or simultaneously. Further, in some exemplary embodiments, some of the actions, acts, blocks, steps, or the like may be omitted, added, modified, skipped, or the like without departing from the scope of the disclosure.

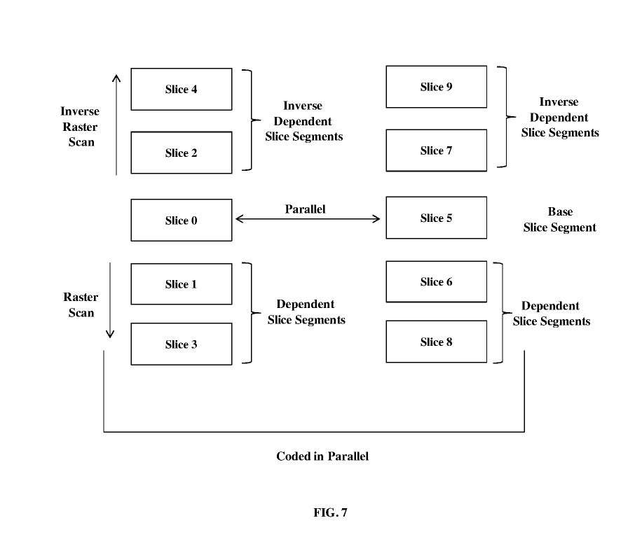

FIG. 7 is a diagram illustrating an example for parallel coding of slice segments of a frame having two base slice segments and a plurality of dependent slice segments, according to an exemplary embodiment. In FIG. 7, the frame is partitioned into slice segments 0 through 9. The slice 0 and slice 5 are base slice segments. Each base slice segment (slice 0 and slice 5) is associated with set of dependent slice segments. Slice segments 1, 3, 6 and 8 are dependent slice segments and slice segments 2, 4, 7 and 9 are inverse dependent slice segments.

It is to be noted that slice segments 1 and 3 are dependent slice segments with respect to slice 0 (base slice segment) and slice segments 2 and 4 are inverse dependent slice segments with respect to slice 0. Slice 1 is dependent on the base slice (slice 0) and slice 3 is dependent on slice 2. Slice 2 is inversely dependent on the base slice (slice 0) and slice 4 is inversely dependent on the slice 2.

Further, it is to be noted that slice segments 6 and 8 are dependent slice segments with respect to slice 5 (base slice segment) and slice segments 7 and 9 are inverse dependent slice segments with respect to slice 5, as shown in the FIG. 7. Slice 6 is dependent on the slice 5 (base slice) and slice 8 is dependent on slice 6. Slice 7 is inversely dependent on slice 5 (base slice) and slice 9 is inversely dependent on slice 7.

With reference to FIG. 2, the selecting unit 104 may select slice segments 0 and 5 as the base slice segments. When slice segments 0 and 5 are selected as the base slice segments, the coding unit 106 may code the slice segments 0 and 5 in the raster scan order in parallel.

The coding unit 106 codes the slice segments 1 and 3 in the raster scan order and slice segments 2 and 4 in the inverse raster scan order. The coding unit 106 codes the slice segments 1 and 2 in parallel with respect to slice 0. Further, the coding unit 106 codes the slice segments 3 and 4 in parallel with respect to slice 0.

The coding unit 106 codes slice segments 6 and 8 in the raster scan order and slice segments 7 and 9 in the inverse raster scan order. The coding unit 106 codes slice segments 6 and 7 in parallel with respect to slice 5 (base slice). Further, the coding unit 106 codes slice segments 8 and 9 in parallel with respect to slice 5. Thus, the coding of the base slice segments and the coding of dependent slice segments with respect to the base slice segment independently occur in parallel. As the dependent slice segments and the inverse dependent slice segments are coded in parallel, multiple cores can be utilized, thereby achieving greater execution speed.

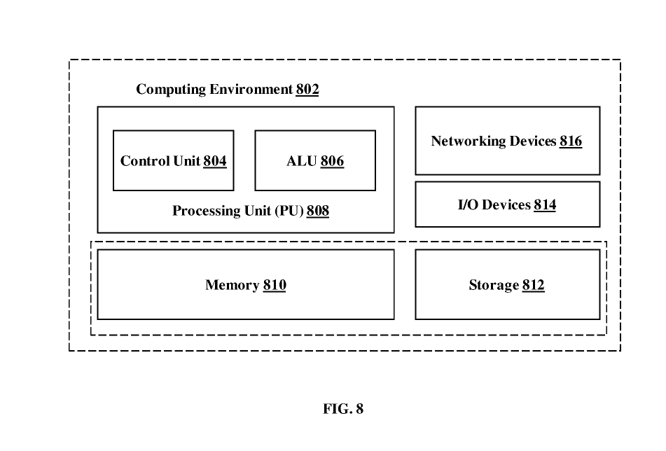

FIG. 8 illustrates a block diagram of a computing environment implementing the method for parallel coding of slice segments, according to an exemplary embodiment.

As depicted in the FIG. 8, the computing environment 802 includes at least one processing unit (PU) 808 that is equipped with a control unit 804 and an Arithmetic Logic Unit (ALU) 806, a memory 810, a storage unit 812, networking devices 816 and Input output (I/O) devices 814. The processing unit 804 is responsible for processing the instructions of the coding methods. The processing unit 808 receives commands from the control unit in order to perform coding processing. Further, any logical and arithmetic operations involved in the execution of the instructions are computed with the help of the ALU 806.

The overall computing environment 802 can be composed of multiple homogeneous and/or heterogeneous cores, multiple CPUs of different kinds, special media and other accelerators. The processing unit 808 is responsible for processing the instructions of the coding methods. Further, the plurality of processing units 808 may be located on a single chip or over multiple chips.

The algorithm comprising of instructions and codes required for the implementation of the coding methods is stored in either the memory unit 810 or the storage 812 or both. At the time of execution, the instructions may be fetched from the corresponding memory 810 or storage 812, and executed by the processing unit 808.

In case of any hardware implementations, various networking devices 816 or external I/O devices 814 may be connected to the computing environment to support the implementation through the networking unit and the I/O device unit.

The exemplary embodiments disclosed herein may be implemented through at least one software program running on at least one hardware device and performing management functions to control the elements. The elements shown in the FIGS. 1 and 8 include blocks which can be at least one of a hardware device, or a combination of hardware device and software module.

The foregoing description of the exemplary embodiments will so fully reveal the general nature of the exemplary embodiments herein that others can, by applying current knowledge, readily modify and/or adapt for various applications such specific exemplary embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the exemplary embodiments herein have been described in terms of preferred embodiments, those skilled in the art will recognize that the exemplary embodiments herein can be practiced with modification within the spirit and scope of the exemplary embodiments as described herein.

1. A method for coding a frame, the method comprising:
partitioning, by a partition unit, a frame into a plurality of slice segments, the plurality of slice segments comprising a base slice segment, a dependent slice segment, and an inverse dependent slice segment;
coding, by a coding unit, the base slice segment; and
coding, by the coding unit, the dependent slice segment and the inverse dependent slice segment in parallel.

2. The method of claim 1, wherein the inverse dependent slice segment is coded in an inverse raster scan order, and the dependent slice segment is coded in a raster scan order, and
wherein the dependent slice segment and the inverse dependent slice segment are coded in parallel with respect to the base slice segment.

3. The method of claim 1, wherein the base slice segment is coded in a raster scan order.

4. The method of claim 1, wherein the inverse dependent slice segment and the dependent slice segment are neighbors of the base slice segment.

5. The method of claim 1, further comprising:
selecting the base slice segment from the frame.

6. The method of claim 1, wherein a set of slice segments from the plurality of slice segments form a tile.

7. An electronic device for coding a frame, the electronic device comprising:
a partition unit configured to partition a frame into a plurality of slice segments, the plurality of slice segments comprising a base slice segment, a dependent slice segment, and an inverse dependent slice segment; and
a coding unit configured to code the base slice segment, and code the dependent slice segment and the inverse dependent slice segment in parallel.

8. The electronic device of claim 7, wherein the coding unit is further configured to code the inverse dependent slice segment in an inverse raster scan order,
wherein the coding unit is further configured to code the dependent slice segment in a raster scan order, and
wherein the dependent slice segment and the inverse dependent slice segment are coded in parallel with respect to the base slice segment.

9. The electronic device of claim 7, wherein the coding unit is further configured to code the base slice segment in a raster scan order.

10. The electronic device of claim 7, wherein the inverse dependent slice segment and the dependent slice segment are neighbors of the base slice segment.

11. The electronic device of claim 7, wherein the partition unit is further configured to select the base slice segment from the frame.

12. The electronic device of claim 7, wherein a set of slice segments from the plurality of slice segments form a tile.

13. A computer program product comprising computer executable program code recorded on a non-transitory computer readable storage medium, the computer executable program code when executed causes a video encoding apparatus to execute a method of encoding a frame, the method comprising:
partitioning a frame into a plurality of slice segments, the plurality of slice segments comprising a base slice segment, a dependent slice segment, and an inverse dependent slice segment;
coding the base slice segment; and
coding the dependent slice segment and the inverse dependent slice segment in parallel with respect to the base slice segment.

14. A video encoding method, the method comprising:
partitioning a frame into a plurality of slice segments;
selecting a base slice segment from among the plurality of slice segments;
determining a dependent slice segment that is dependent upon the base slice segment from among the plurality of slice segments;
determining an inverse dependent slice segment that is inversely dependent upon the base slice segment from among the plurality of slice segments; and
encoding the dependent slice segment and the inverse dependent slice segment in parallel.

15. The method of claim 14, wherein the dependent slice segment is a slice segment for which a value of a syntax element of a slice segment header of the dependent slice segment is inferred from the base slice segment, and
wherein the inverse dependent slice segment is a slice segment inversely dependent on the base slice segment for which a value of a syntax element of the inverse dependent slice is inferred from the base slice segment.

16. The method of claim 15, wherein the encoding comprises:
encoding the dependent slice segment according to a raster scan order; and
encoding the inverse dependent slice segment according to an inverse raster scan order, in parallel to encoding the dependent slice segment.

17. The method of claim 16, wherein the encoding the dependent slice segment comprises a first thread encoding the dependent slice segment, and
wherein the encoding the inverse dependent slice segment comprises a second thread encoding the inverse dependent slice segment, in parallel to the first thread encoding the dependent slice segment.
